(19) United States
(12) Patent Application Publication
(10) Pub. No.: US 2026/0251779 A1
(43) Pub. Date: Aug. 27, 2026

(54) SYSTEM AND METHOD FOR ESTIMATING ROAD BOUNDARY USING AUTONOMOUS DRIVING SENSOR AND ARTIFICIAL INTELLIGENCE

(71) Applicants: HYUNDAI MOTOR COMPANY, Seoul (KR); Kia Corporation, Seoul (KR)

(72) Inventor: Yeong Hun KIM, Hwaseong-si (KR)

(73) Assignees: HYUNDAI MOTOR COMPANY, Seoul (KR); Kia Corporation, Seoul (KR)

(21) Appl. No.: 19/322,402

(22) Filed: Sep. 8, 2025

(30) Foreign Application Priority Data
Feb. 24, 2025 (KR) 10-2025-0023815

(51) Int. Cl. G01S 13/89; B60W 60/00; G01S 7/41; G01S 13/58

(52) U.S. Cl. CPC G01S 13/89; B60W 60/001; G01S 7/417; G01S 13/583; B60W 2420/408; B60W 2552/53

(57) ABSTRACT

A system and a method for recognizing a road boundary or an object corresponding to the road boundary are provided. The system includes a processor configured to recognize, using an artificial intelligence (AI) module, an object from data and a memory storing the data. The processor is configured to perform, using the AI module, receiving a plurality of points generated from one or more stopped objects together with a coordinate value on coordinates of each point in space in real time, calculating a driving direction weighted Euclidean distance between the plurality of points, performing clustering of points with the shortest driving direction weighted Euclidean distance among the plurality of points and recognizing the road boundary or the object corresponding to the road boundary and controlling a vehicle based on the clustering result.

### CROSS-REFERENCE TO RELATED APPLICATION

This application claims the benefit of priority to Korean Patent Application No. 10-2025-0023815, filed in the Korean Intellectual Property Office on Feb. 24, 2025, the entire contents of which are incorporated herein by reference.

### TECHNICAL FIELD

The present disclosure relates to a system and a method for estimating a road boundary using an autonomous driving sensor an artificial intelligence (AI), and more particularly, relates to a system and a method for optimally estimating a boundary of the road via distance measurement between points based on a current driving route for an object point recognized from the autonomous driving sensor and clustering via it.

### BACKGROUND

Recently, with the development and commercialization of autonomous vehicle, there has been an increase in examples of using various sensors and an artificial intelligence (AI) technology to support an autonomous driving function of the vehicle. For example, research on which object is present in front of a vehicle which is driving, on how far the distance between the object and the vehicle is, on which algorithm the vehicle should respond according to for each specific situation to ensure safety has continued.

Thus, a vehicle sensor technology has become more advanced. There is a trend towards loading high-performance sensors, such as light detection and ranging (LiDAR) for recognizing a surrounding environment using laser beams, radio detection and ranging (RADAR) using radio waves, an ultrasonic sensor, a fisheye camera capable of capturing a 360-degree image, a multifocal lens, and a global positioning system (GPS), into the vehicle.

It is possible to aggregate the measured results obtained from the plurality of sensors to implement a so-called super sensor vehicle. The concept of a super sensor in self-driving or autonomous driving refers to a technology for combining measured values of various sensors to more accurately recognize a surrounding environment, rather than relying on an individual sensor, for convenience or safety of vehicle driving. As information and communications technology (ICT) and cloud technology are added to this, a sensor necessary for autonomous driving and an AI algorithm associated with it are becoming more advanced than ever, for example, may remotely accumulate data in units of a fleet of vehicles, rather than targeting only one vehicle, and may train an AI server and a database to increase the reliability of determination of the vehicle sensor.

Only if a guardrail of the road or the like is accurately measured using a sensor for autonomous driving, such as RADAR for recognizing an external environment thereamong, it is possible to perform safe autonomous driving.

However, although the autonomous driving sensor is developed and an AI technology is advanced, there occurs a case in which the boundary of the road on which the vehicle is driving is not clearly recognized or is misrecognized. Thus, there is a need for a technology capable of accurately estimating a boundary of a road.

### SUMMARY

The present disclosure has been made to solve the above-mentioned problems occurring in the prior art while advantages achieved by the prior art are maintained intact.

An aspect of the present disclosure provides a system and a method for estimating a road boundary using an autonomous driving sensor and a processor, which uses an artificial intelligence (AI), and more particularly, provides a system and a method for optimally estimating a boundary of the road via distance measurement between points based on a current driving route for an object point recognized from the autonomous driving sensor and clustering via it.

The technical problems to be solved by the present disclosure are not limited to the aforementioned problems, and any other technical problems not mentioned herein will be clearly understood from the following description by those skilled in the art to which the present disclosure pertains.

The present disclosure may be implemented in the following various aspects to address all or at least some of the above-mentioned technical problems.

According to an aspect of the present disclosure, a system for recognizing a road boundary or an object corresponding to the road boundary may include a processor configured to recognize, using an artificial intelligence (AI) module, an object which is present in a surrounding environment from data input from an autonomous driving sensor and a memory storing the data. The processor may perform, using the AI module, receiving a plurality of points generated from one or more stopped objects among objects which are present around a road depending on a current driving direction together with a coordinate value of each point on coordinates in space in real time from the autonomous driving sensor, calculating a driving direction weighted Euclidean distance between the plurality of points based on a driving distance according to the driving direction and a weight determined for each reference axis on the coordinates in space, performing clustering of points with the shortest driving direction weighted Euclidean distance among the plurality of points and recognizing the road boundary or the object corresponding to the road boundary and controlling a vehicle based on the clustering result.

In the system according to another aspect of the present disclosure, the driving direction weighted Euclidean distance may be calculated by Equation below, if the coordinates in space are 2 dimensions,

$${d}_{euc} ( {p}_{i} , {p}_{i + 1} ) = \sqrt{{w}_{{x}^{′}} \cdot Δ {x}^{′2} + {w}_{{y}^{′}} \cdot Δ {y}^{′2}} \qquad < Equ a t i on >$$

Herein, the vertical distance, Δx′, in the driving distance is determined as Δx′=θᵢ₍ᵢ₊₁₎·R, the horizontal distance, Δy′, in the driving distance is determined as Δy′=√p̅ᵢ̅₊̅₁̅p̅_̅{̅R̅}̅−p̅ᵢ̅p̅_̅{̅R̅}̅, wₓ′ is the weight on the vertical axis of the relative coordinates generated according to the driving direction, w_{y}′ is the weight on the horizontal axis of the relative coordinates generated according to the driving direction, p_{R} is the center of rotation in the current driving direction on the coordinates in space, R is the radius of rotation in the current driving direction on the coordinates in space, pᵢ and pᵢ₊₁ correspond to the ith point and the i+1th point among the plurality of points, respectively, and θᵢ₍ᵢ₊₁₎ is the angle formed on the basis of the center of rotation by the ith point and the i+1th point.

In the system according to another aspect of the present disclosure, it may be assumed that the weight on the vertical axis and the weight on the horizontal axis have a relationship, wₓ′<w_{y}′.

In the system according to another aspect of the present disclosure, the processor may additionally execute, using the AI module, a post-processing step of determining that a point at which the driving direction weighted Euclidean distance is greater than a certain threshold among the plurality of point is noise which does not constitute the road boundary.

In the system according to another aspect of the present disclosure, receiving a plurality of points may include receiving the coordinate value of each point in real time, only if the stopped objects are present in a predetermined region of interest (ROI).

In the system according to another aspect of the present disclosure, the autonomous driving sensor includes radio detection and ranging (RADAR), the stopped objects may be determined based on whether there is a speed of movement by a Doppler effect recognized by the RADAR.

In the system according to another aspect of the present disclosure, the processor may additionally execute, using the AI module, a post-processing step of determining points which are present in a region outside the result of recognizing the road boundary or the object corresponding to the road boundary among the plurality of points as mirroring noise.

In the system according to another aspect of the present disclosure, the processor may additionally execute, using the AI module, a post-processing step of feeding back that a point determined as constituting the road boundary or the object corresponding to the road boundary is the stopped object and feeding back that a point determined as not constituting the road boundary or the object corresponding to the road boundary is not the stopped object to process point erroneous merge noise.

In the system according to another aspect of the present disclosure, the processor may generate, using the AI module, a dendrogram based on the driving direction weighted Euclidean distance for the plurality of points upon the clustering to hierarchically perform the clustering.

In the system according to another aspect of the present disclosure, the processor may generate, using the AI module, a dimensional gate surrounding two points with the shortest driving direction weighted Euclidean distance on the basis of relative coordinates generated according to the driving direction, upon the clustering and may connect two or more dimensional gates to recognize the road boundary or the object corresponding to the road boundary, if there are two or more overlapped regions in the dimensional gate.

According to another aspect of the present disclosure, a method for recognizing a road boundary or an object corresponding to the road boundary may include receiving, by a processor, using an artificial intelligence (AI) module, a plurality of points generated from one or more stopped objects among objects which are present around a road depending on a current driving direction together with a coordinate value of each point on coordinates in space in real time from anautonomous driving sensor, calculating, by the processor, using the AI module, a driving direction weighted Euclidean distance between the plurality of points based on a driving distance according to the driving direction and a weight determined for each reference axis on the coordinates in space, performing, by the processor, using the AI module, clustering of points with the shortest driving direction weighted Euclidean distance among the plurality of points and recognizing the road boundary or the object corresponding to the road boundary and controlling a vehicle based on the clustering result.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating the overall system for controlling a vehicle to automatically recognize an object and perform autonomous driving according to an embodiment of the present disclosure;

FIG. 2 is a drawing illustrating a driving situation on a guardrail road to which a system and a method for estimating a road boundary using an autonomous driving sensor and AI are applied according to an embodiment of the present disclosure;

FIG. 3 is a flowchart illustrating a road boundary estimation algorithm using an autonomous driving sensor and AI according to an embodiment of the present disclosure;

FIG. 4 is a drawing for describing a scheme for performing point clustering depending on a driving direction in a road boundary estimation algorithm using an autonomous driving sensor and AI according to an embodiment of the present disclosure;

FIGS. 5A and 5B are drawings for describing a difference if performing point clustering depending on a driving direction in a road boundary estimation algorithm using an autonomous driving sensor and AI, compared to if simply performing point clustering based on a Euclidean distance, according to an embodiment of the present disclosure;

FIG. 6 is a drawing for describing an example of performing point clustering depending on a driving direction in a road boundary estimation algorithm using an autonomous driving sensor and AI, by using a dendrogram technique according to an embodiment of the present disclosure;

FIGS. 7A, 7B, and 7C are drawings for describing a scheme for performing point clustering depending on a driving direction in a road boundary estimation algorithm using an autonomous driving sensor and AI, by defining a new horizontal axis and a new vertical axis on the basis of the driving direction according to an embodiment of the present disclosure; and

FIG. 8 is a block diagram illustrating a computing system for autonomous vehicle control and object recognition computation according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

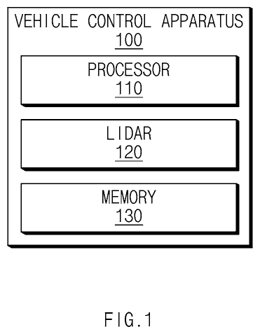

FIG. 1 is a block diagram illustrating the overall system for controlling a vehicle to automatically recognize an object and perform autonomous driving according to an embodiment of the present disclosure.

Referring to FIG. 1, a vehicle control apparatus 100 according to an embodiment of the present disclosure may be implemented inside or outside a vehicle and some of the components included in the vehicle control apparatus 100 may be implemented inside or outside the vehicle. In this case, the vehicle control apparatus 100 may be integrally configured with control units (controllers) in the vehicle or may be implemented as a separate device to be connected with the control units of the vehicle by a separate connection means. For example, the vehicle control apparatus 100 may further include components which are not shown in FIG. 1.

The vehicle control apparatus 100 according to an embodiment may include a processor 110, an autonomous driving sensor 120 (e.g., light detection and ranging (LiDAR), radio detection and ranging (RADAR), or the like), and a memory 130. The processor 110, the LiDAR 120, and the memory 130 may be electronically or operably coupled with each other by an electronical component including a communication bus. For reference, the autonomous driving sensor 120 is interchangeably used as the LiDAR 120 or the RADAR 120 to use the reference numeral, if necessary. The LiDAR or the RADAR is only one of a large number of sensors available in the autonomous driving sensor.

Hereinafter, that pieces of hardware are operably coupled with each other may include that a direct connection or an indirect connection between the pieces of hardware is established wired and/or wirelessly, such that second hardware is controlled by first hardware among the pieces of hardware.

The different blocks are illustrated, but an embodiment is not limited thereto. For example, some of the pieces of hardware of FIG. 1 may be included in a single integrated circuit including a system on a chip (SoC). Types of the pieces of hardware included in the vehicle control apparatus 100 and/or the number of the pieces of hardware are/is not limited to those shown in FIG. 1. For example, the vehicle control apparatus 100 may include only some of the pieces of hardware shown in FIG. 1.

The vehicle control apparatus 100 according to an embodiment may include hardware for processing data based on one or more instructions. For example, the hardware for processing the data may include the processor 110. For example, the hardware for processing the data may include an arithmetic and logic unit (ALU), a floating point unit (FPU), a field programmable gate array (FPGA), a central processing unit (CPU), and/or an application processor (AP). The processor 110 may have a structure of a single-core processor or may have a structure of a multi-core processor including a dual core, a quad core, a hexa-core, or an octa core.

According to an embodiment, the processor 110 may include at least one of a graphic processing unit (GPU) or a neural processing unit (NPU), or any combination thereof. For example, the GPU may be referred to as a visual processing unit (VPU). For example, the NPU may be referred to as a neural network processing unit.

The vehicle control apparatus 100 according to an embodiment may include a depth sensor for detecting an external object. For example, the depth sensor for detecting the external object may include at least one of a time of flight (ToF) sensor, the LiDAR 120, a structured light sensor, an ultrasonic sensor, an infrared sensor, radio detection and ranging (RADAR), or an optical distance sensor, or any combination thereof. Hereinafter, a description will be given of LiDAR for convenience of description.

The vehicle control apparatus 100 according to an embodiment may include the LiDAR 120 for obtaining a plurality of points based on a pulse laser signal. For example, the LiDAR 120 may obtain datasets for identifying a surrounding thing around the vehicle control apparatus 100 (or the vehicle including the vehicle control apparatus 100). For example, the LiDAR 120 may identify at least one of a position of the surrounding thing, a motion direction of the surrounding thing, or a speed of the surrounding thing, or any combination thereof, based on that a pulse laser signal radiated from the LiDAR 120 is reflected from the surrounding thing to return.

For example, the LiDAR 120 may obtain datasets representing an external object in a space formed by an x-axis, a y-axis, and a z-axis, based on the pulse laser signal reflected from the surrounding thing. For example, the LiDAR 120 may obtain datasets including a plurality of points in the space formed by the x-axis, the y-axis, and the z-axis, based on receiving the pulse laser signal at a specified period. For example, the plurality of points may include points representing the external object in a three-dimensional (3D) virtual coordinate system. The 3D virtual coordinate system may include at least one of a vehicle coordinate system or a LiDAR coordinate system, or any combination thereof. However, the example of the 3D virtual coordinate system is not limited to those described above.

The memory 130 of the vehicle control apparatus 100 according to an embodiment may include a hardware component for storing data and/or an instruction input and/or output from the processor 110 of the vehicle control apparatus 100. For example, the memory 130 may include a volatile memory including a random-access memory (RAM) and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

One or more instructions indicating computation and/or an operation to be performed using data by the processor 110 of the vehicle control apparatus 100 may be stored in the memory 130 of the vehicle control apparatus 100. A set of the one or more instructions may be referred to as a program, firmware, an operating system, a process, a routine, a sub-routine, and/or an application.

Hereinafter, that the application is installed in the vehicle control apparatus 100 may mean that one or more instructions provided in the form of the application are stored in the memory 130, which may mean that the one or more applications are stored in a format executable by the processor 110 of the vehicle control apparatus 100 (e.g., as a file with an extension specified by the operating system of the vehicle control apparatus 100).

For example, the memory 130 may include a first neural network model for detecting an object. For example, the memory 130 may include a second neural network model for outputting a type of the plurality of points obtained by the LiDAR 120 and/or a score of the plurality of points.

In an embodiment, the processor 110 may obtain at least one of a first virtual box for representing a target object or a first class indicating a type of the target object, or any combination thereof, based on the plurality of points obtained via the LiDAR 120 and the first neural network model stored in the memory 130.

In an embodiment, the processor 110 may obtain at least one of the first virtual box for representing the target object or the first class indicating the type of the target object, or any combination thereof, based on inputting the plurality of points to the first neural network model. For example, the first neural network model may include an object detection model. For example, the target object may include an external object located within a specified distance from the vehicle control apparatus 100 (or a host vehicle including the vehicle control apparatus 100). For example, the target object may include an object which identified by the vehicle control apparatus 100 and is continuously tracked. For example, the type of the target object may include a plurality of types for classifying the target object. For example, the type of the target object may include at least one of a first type indicating the ground or a second type indicating a type different from the ground, or any combination thereof. However, the type of the target object is not limited to those described above. For example, the type of the target object may include, but is not limited to, at least one of a third type indicating a person or a fourth type indicating a vehicle, or any combination thereof.

In an embodiment, the processor 110 may obtain at least one of first partial points corresponding to at least a portion of the target object among the plurality of points, based on the plurality of points and the second neural network model or a second class identified via the first partial points and indicating the type of the target object, or any combination thereof, based on the plurality of points and the second neural network model. For example, the second neural network model may include a segmentation model.

For example, the second neural network model may include a neural network model for obtaining the type of the plurality of points and the score of the plurality of points.

For example, the processor 110 may obtain the first partial points corresponding to the at least a portion of the target object among the plurality of points, based on inputting the plurality of points to the second neural network model. For example, the processor 110 may identify the type of the plurality of points, based on inputting the plurality of points to the second neural network model. For example, the processor 110 may obtain the first partial points corresponding to the at least a portion of the target object among the plurality of points, based on the type of each of the plurality of points.

According to an embodiment, the processor 110 may perform a first specified algorithm for the plurality of points. For example, the processor 110 may perform the first specified algorithm for classifying the type of each of the plurality of points, for the plurality of points. For example, the processor 110 may classify second partial points corresponding to a specified type among the plurality of points. For example, the specified type may include a type representing the ground.

For example, the processor 110 may classify the second partial points corresponding to the specified type, based on performing the first specified algorithm for the plurality of points, and may exclude the second partial points from the plurality of points to obtain (or identify) the first partial points.

In an embodiment, the processor 110 may obtain at least one of a partial class for obtaining the second class, or the score of each of the plurality of points, or any combination thereof, based on inputting the plurality of points to the second neural network model. For example, the processor 110 may obtain the partial class and the score of each of the plurality of points, based on inputting the plurality of points to the second neural network model. For example, the partial class may include classifying each of the plurality of points as any type.

For example, the processor 110 may fuse the partial class, the score of each of the plurality of points, and the second partial points. For example, the processor 110 may perform clustering, based on fusing the partial class, the score of each of the plurality of points, and the second partial points. For example, the clustering may include grouping the first partial points corresponding to the at least a portion of the target object.

For example, the processor 110 may obtain a point cloud for generating a second virtual box, based on the first partial points. For example, the processor 110 may obtain the point cloud, based on grouping the first partial points.

For example, the processor 110 may generate the second virtual box which is different from the first virtual box and is for representing the target object, based on the point cloud. For example, the second virtual box may include a box including at least some of the first partial points.

For example, the processor 110 may identify a heading direction indicating a progress direction of the target object, based on at least one of the first partial points or the point cloud, or any combination thereof.

For example, the processor 110 may identify a position of the second virtual box on the virtual coordinate system, based on the at least one of the first partial points or the point cloud, or the any combination thereof. For example, the processor 110 may identify a size of the second virtual box, based on the at least one of the first partial points or the point cloud, or the any combination thereof. For example, the processor 110 may identify a second class, based on the at least one of the first partial points or the point cloud, or the any combination thereof. For example, the processor 110 may identify at least one of the heading direction of the progress direction of the target object, the position of the second virtual box on the virtual coordinate system, the size of the second virtual box, or the second class, or any combination thereof, based on the at least one of the first partial points or the point cloud, or the any combination thereof. For example, the processor 110 may identify a heading direction of a bounding box, based on at least one of the first virtual box, the first class, the heading direction of the second virtual box, the position of the second virtual box, the size of the second virtual box, or the second class, or any combination thereof. For example, the processor 110 may identify a position of the bounding box on the virtual coordinate system, based on the at least one of the first virtual box, the first class, the heading direction of the second virtual box, the position of the second virtual box, the size of the second virtual box, or the second class, or the any combination thereof. For example, the processor 110 may obtain a third class indicating the type of the target object corresponding to the bounding box, based on the at least one of the first virtual box, the first class, the heading direction of the second virtual box, the position of the second virtual box, the size of the second virtual box, or the second class, or the any combination thereof. For example, the processor 110 may obtain at least one of the heading direction of the bounding box, the position of the bounding box on the virtual coordinate system, or the third class indicating the type of the target object corresponding to the bounding box, based on the at least one of the first virtual box, the first class, the heading direction of the second virtual box, the position of the second virtual box, the size of the second virtual box, or the second class, or the any combination thereof.

For example, the processor 110 may assign a first identifier for tracking the second virtual box to the second virtual box. For example, the processor 110 may assign a second identifier corresponding to the first identifier to the bounding box.

For example, the processor 110 may track the bounding box using the second identifier. For example, the processor 110 may track the target object, based on identifying a plurality of bounding boxes including the bounding box to which the second identifier is assigned, at a plurality of frames. For example, because the second identifier is an identifier assigned to the bounding box corresponding to the target object, the processor 110 may identify the plurality of bounding boxes to which the second identifier is assigned, at the plurality of frames, to track the target object.

In an embodiment, the processor 110 may output the bounding box corresponding to the target object, based on at least one of the first virtual box, the first class, the first partial points, or the second class, or any combination thereof. For example, the bounding box may include an example of representing the target object on the virtual coordinate system in the form of a hexahedron. In some embodiments, the processor 110 may control a vehicle based on the output.

Hereinafter, a description will be given briefly of operations performed by the CPU, the GPU, and/or the NPU included in the processor 110.

According to an embodiment, the processor 110 may include at least one of the CPU, the GPU, or the NPU, or any combination thereof. For example, at least one of the GPU or the NPU, or any combination thereof may obtain the first virtual box and the first class, based on the first neural network model. For example, at least one of the GPU or the NPU may obtain the first virtual box and the first class. For example, the at least one of the GPU or the NPU, or the any combination thereof may obtain the partial class for obtaining the second class and the score of each of the plurality of points, based on the second neural network model. For example, the at least one of the GPU or the NPU may obtain the partial class for obtaining the second class and the score of each of the plurality of points, based on the second neural network model. For example, the CPU may classify the second partial points corresponding to the specified type among the plurality of points, based on performing the first specified algorithm for classifying the type of each of the plurality of points, for the plurality of points.

As described above, the vehicle control apparatus 100 according to an embodiment may include the at least one processor 110. The vehicle control apparatus 100 may detect the target object using the at least one processor 110 to accurately detect the target object. Furthermore, by performing a parallel process, apparatus 100 may reduce a load for each the vehicle control processor.

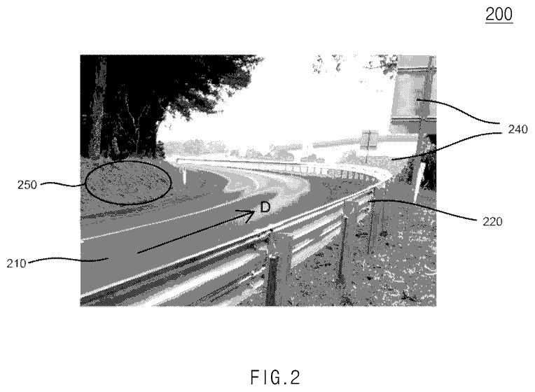

Meanwhile, before seeing FIG. 2, an object recognition-related description based on the autonomous driving sensor is added for the overall understanding of AI object recognition according to the present disclosure as follows.

An object recognition process by the LiDAR 120 (or the RADAR) or the AI module passes through three steps, such as pre-processing, segmentation, and tracking.

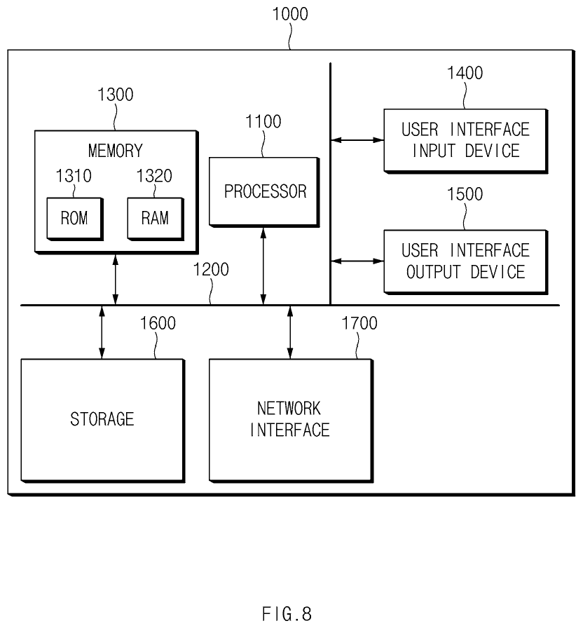

The object recognition system 1000 (refer to FIG. 8) according to the present disclosure may pass through pre-processing before executing an object recognition function. The pre-processing may include, for example, an operation of removing points forming the ground, based on laser sensing data (i.e., raw data) input from the LiDAR 120 (or the RADAR). Because it is able to be misrecognized as if there is any object on the ground by a laser beam (however, a radio wave for the RADAR) reflected from the ground, the process of separating the ground from a thing which is not the ground may be performed in the pre-processing step and may also be performed in the segmentation step if necessary.

For example, the pre-processing in AI object recognition is understood as a process in which an image processing tool of the AI module in the processor 110 removes noise of a point cloud image, for example, may reduce the total number of points which are present in the point cloud image via a voxel downsampling technique or the like to promote computational efficiency.

For reference, the point cloud image may be displayed in a bird's eye view (BEV) scheme. If a sensor map is generated as if it were a bird's eye view of the city while the bird flies in the sky, this is referred to as a BEV image.

In other words, as described above, the LiDAR 120 (or the RADAR) transmits a laser beam to a surrounding environment and records a time when the laser beam is reflected from an object which is present in the outside to return, thus generating a point every many laser signals and calculating a distance to the point. By repeatedly transmitting many laser beams (however, radio waves for the RADAR), the processor 110 may generate a real-time map for the surrounding environment as a BEV type of 3D map and may generate the real-time map as a two-dimensional (2D) map if necessary.

The line or surface shown in black and white on the point cloud map is actually composed of innumerable points (each of which is generated by the laser beam (however, the radio wave for the RADAR) of the LiDAR 120 (or the RADAR). Due to this, a sensing image of the autonomous driving sensor 120 is called a point cloud image. Of course, for example, if a red, green, blue-depth (RGB-D) sensor and the autonomous driving sensor 120 are combined with each other, a point cloud image may be re-implemented in color.

If it is difficult for humans to recognize a thing using only one of many points in the point cloud image, but, for example, if they synthetically look at the point cloud from the BEV's point of view or in the same way as a 2D floor plan, they may roughly guess whether the surrounding environment around the vehicle which is currently performing autonomous driving is any shape. In addition, for example, it is possible to recognize a vehicle, a bus, a pedestrian, a street tree, a traffic sign, or the like which is present in the point cloud image. Such a thing or person is called an object in an AI image recognition technology. It is possible to classify the object as a class which belongs to a group of the specific nature, such as a vehicle class or a bus class.

The help of a deep AI neural network is required to classify whether any object in the point cloud image is the vehicle class or the bus class. AI training should precede to find objects in the point cloud image via the AI neural network and identify a class of the object.

For example, a dataset (source: https://pandaset.org/#data-collection) called PANDASET™ includes more than 48,000 camera images (images captured primarily in the Silicon Valley region of the United States) and includes more than 16,000 LiDAR scan images. A total of 28 classes, such as pedestrians, cars, bicycles, construction site signs, and traffic signs, are arranged in the form of an annotation in these images. Furthermore, the point cloud image may be visualized to suit an option desired by the user using a point cloud working tool, such as Open3D™ (source: https://www.open3d.org/). Because the LiDAR 120 (or the RADAR) is able to detect a distance, it may more realistically reproduce a 3D sensing map image in such a manner as to display a thing in a long distance in, for example, a deep blue and display a thing in a short distance in a light blue, when the point cloud image is visually processed using, for example, Open3D™.

In addition, as described above, the technology, for example, voxel (3D pixel) downsampling, may be applied to the point cloud image to pre-process an original image (i.e., raw data). Herein, the voxel refers to a 3D pixel in the shape of a regular hexahedron and the voxel downsampling is a technology for reducing the number of points not to require excessive AI computation, even while maintaining a structure of various objects included in the point cloud.

Meanwhile, the LiDAR 120 (or the RADAR) radiates, for example, m laser beams n times during one scan cycle. In this case, the scan value of the laser beam which collides with an external object to return constitutes an (m×n) matrix. This (m×n) matrix data is called a range image. Each point constituting the LiDAR point cloud image may include depth (i.e., range) information and may further include intensity, an azimuth, an inclination, or the other additional information of the returned laser pulse. The range image is a large amount of datasets, for example, Waymo™ open dataset (WOD). It is possible to perform AI learning of the range image.

A range view (RV) refers to a technique for converting a 3D point cloud into a 2D scene, for example, a 2.5D scene to represent the 3D point cloud as a 3D map that humans are able to intuitively understand, like an analog picture, rather than a large number of points. The 3D point cloud image has 2D coordinates in the range view image, but the 3D laser-related information (e.g., the angle, the inclination, the intensity, and the like) which is recorded when previously obtaining the range image is not discarded. If a variable called a width is applied to (x, y) coordinates among (x, y, z) coordinate values of the 3D image to obtain a coordinate on one axis in two dimensions and range image information indicating a range (depth) and a variable called a height are applied to the (z) coordinate to obtain a coordinate of the other axis in two dimensions, this is generated as a 2D range view image.

In addition, the AI algorithm according to the present disclosure may include a convolutional neural network (CNN). The CNN is an AI training module frequently used to extract a feature (or a feature point) from image data. To this end, there is a dataset composed of tens of thousands of commercially available images. The CNN currently has a version capable of processing each of one-dimensional to three-dimensional images. In other words, the result of a range view image processing tool is learned by the CNN to perform a function of helping AI to accurately recognize an object in an image.

Because a thing present around an autonomous vehicle is finally recognized by a machine, the operation of generating a ground truth (GT) bounding box on the map generated by the above-mentioned autonomous driving sensor is also an important process in object recognition. Ground truth (GT) in machine learning is a term used when indicating an original value and a real value of data AI wants to learn. It may be usually viewed as a kind of image annotation overlaid on the point cloud image as a bounding box with a box-shaped boundary.

In other words, the AI module fetches a label to group various objects to recognize the object. Of course, an interval of 3D data points used to output a GT bounding box may be set, which may be set such that about 50 to 1000 LiDAR point cloud points are included in one GT bounding box.

Of course, there is no GT annotation in original data (or raw data) captured by the sensor, such as the LiDAR 120 (or the RADAR), while the vehicle is driving. The processor 110 should recognize a target which belongs to various classes, such as the road sign of the road, a crosswalk, a pedestrian, the other vehicle, and a center line, as an object. The GT annotation is a means used to compare the result of determining the object recognized by the AI algorithm of the processor 110 with the reality to measure an error in object recognition and evaluate AI performance sometimes. A GT bounding box overlaid on the original image in the form of an annotation may be set manually by the user, but there is representatively a commercially available GT computation tool, such as grid-striding.

Meanwhile, if the AI object recognition module is driven, a predicted bounding box may be checked. The result of being recognized as an object of a specific class by the processor 110 from the original image data obtained from the LiDAR 120 (or the RADAR) or the like is represented in the form of another bounding box similar to the GT bounding box. The predicted bounding boxes are the result of being calculated by autonomous driving AI, which is different from the GT bounding box. The predicted bounding box may be identical to the GT bounding box, but may fail to be identical to the GT bounding box or may not at all have a region where the predicted bounding box and the GT bounding box overlap with each other.

For reference, because it is unable to conclude that an object of a specific class is actually present at a certain position definitely using only predicted bounding boxes, the predicted bounding boxes are usually called probability boxes (P-Boxes) or predicted bounding boxes.

Segmentation processing performed after the pre-processing refers to displaying a specific portion (e.g., traffic lights) of the road in, for example, red and displaying the rest (bituminous road) in blue. Clustering the point cloud into a certain group and generating a P-Box may be performed in the segmentation step. For reference, there is a technology called cluster expansion. Herein, an expansion target may include a cluster up to a seed point and all points within an epsilon distance (the minimum distance constituting the cluster).

In other words, clustering based on the point cloud and P-Box generation proceeds upon the segmentation processing. For example, an AI network which performs segmentation is used to obtain a point label from the LiDAR 120 (or the RADAR).

The present disclosure proposes a “rule-based” road surface recognition and label fusion technique to solve a ground surface recognition error problem which occurs upon segmentation. It is fine that any of various techniques, such as road surface recognition based on a slope, grid-based road surface recognition, and the other non-planar based road surface recognition, is representatively applied to the road surface recognition algorithm.

For reference, semantic segmentation is a task for attaching a unique class label to respective points in the point cloud generated by the LiDAR 120. The semantic segmentation in an imaging technology of the sensor 120 is a technology for finding and using meaningful information from data of the sensor 120 for object recognition or scene representation necessary to implement autonomous driving. There are already various semantic segmentation AI modes, such as a projection-based method, a point-based method, and a sparse convolution-based method. For example, the semantic segmentation result may be the AI computation result performed together with the NVIDIA DRIVE™ AGX system by the processor 110. Via such a configuration, various colors may be added to, for example, the point cloud image.

The sensor image passes through the process called post-processing after the segmentation process. The post-processing refers to converting point cloud data into a 3D map or modeling, which is information meaningful for autonomous driving. A process of finally removing noise of the point cloud image or an error in the point cloud image, recognizing an object, such as a vehicle or a pedestrian, from the point cloud, and attaching and registering a unique identifier to the point cloud information if necessary is also included in the post-processing.

FIG. 2 is a drawing illustrating a driving situation 200 on a guardrail road to which a system and a method for estimating a road boundary using an autonomous driving sensor and AI are applied according to an embodiment of the present disclosure. Particularly, it is noted that the boundary of the road curves in the driving situation 200 shown in FIG. 2.

In other words, because the road 210 is curved and a guardrail 220 which is an object corresponding to the boundary of the road 210 is also curved, the present disclosure proposes a technology capable of accurately recognizing the boundary of the road 210 even in a situation in which a vehicle 230 (not shown in FIG. 2) is driving on complex driving route D including any degree of the radius of rotation as well as a straight route. Of course, in the driving situation 200 shown in FIG. 2, there may be an object 240 out of the road boundary, such as a traffic sign or a thicket, which does not constitute the road boundary, and there may be a terrain adjacent to a road opposite to the road, as shown in reference numeral 250.

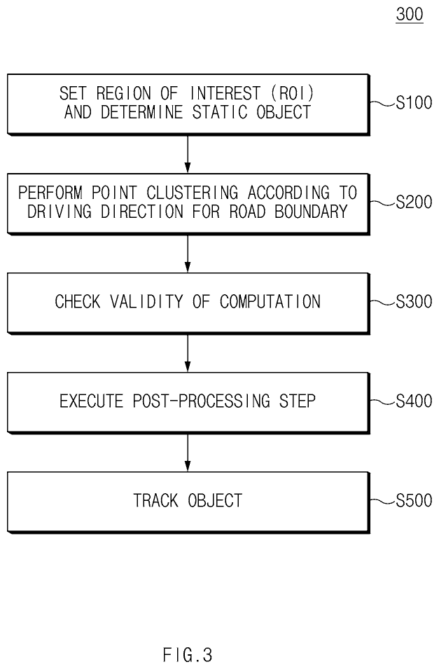

FIG. 3 is a flowchart illustrating a road boundary estimation algorithm 300 using an autonomous driving sensor and AI according to an embodiment of the present disclosure. The algorithm 300 according to the present disclosure may be performed by a processor 110 or is performed more macroscopically by a computing system 1000 which will be described below. Hereinafter, a description will be given of a core technology of the present disclosure with reference to FIG. 3.

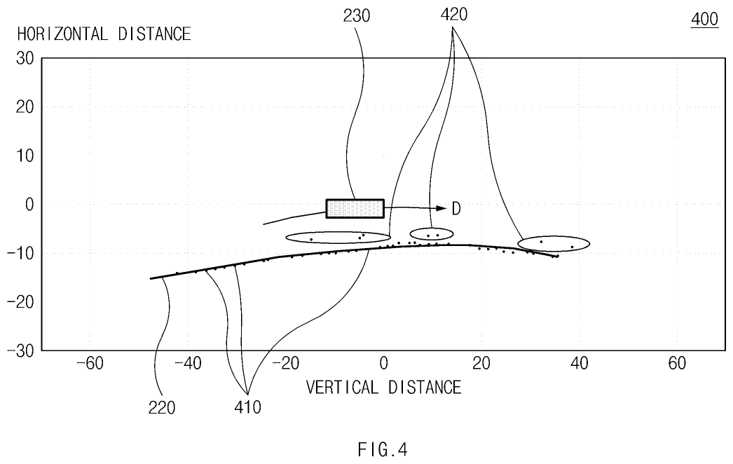

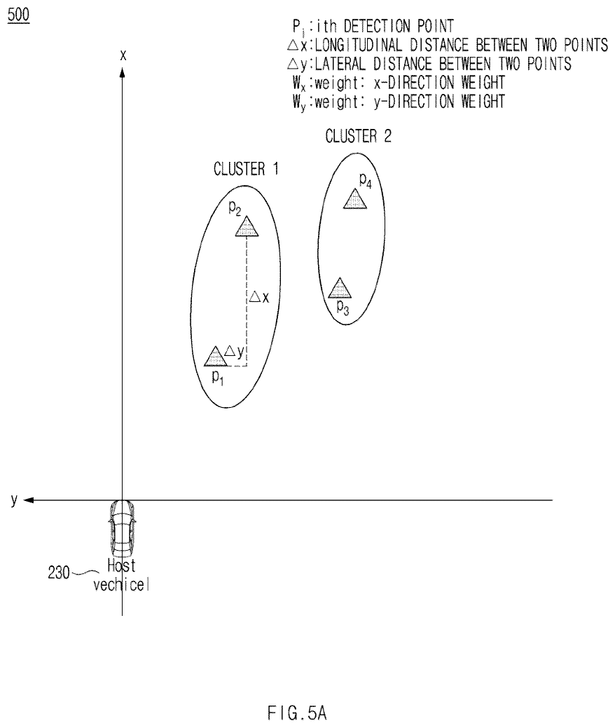

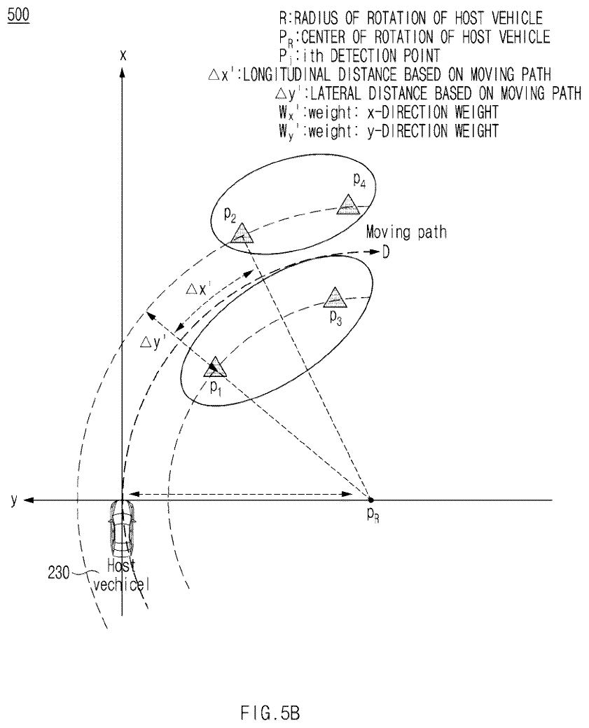

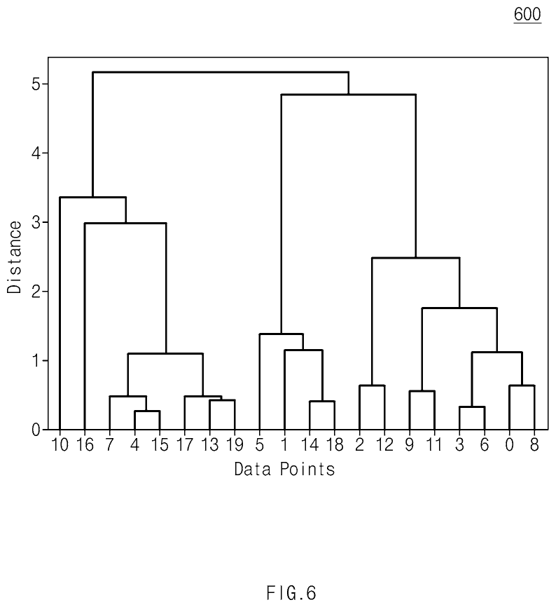

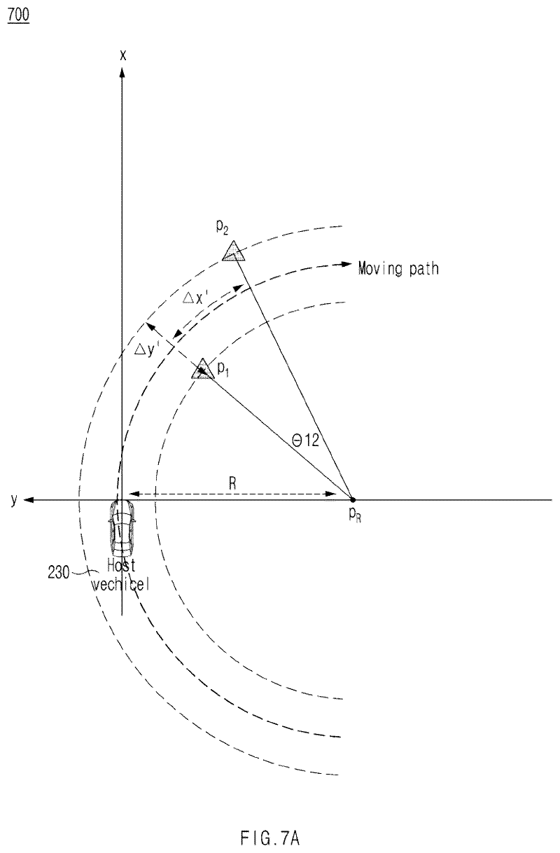

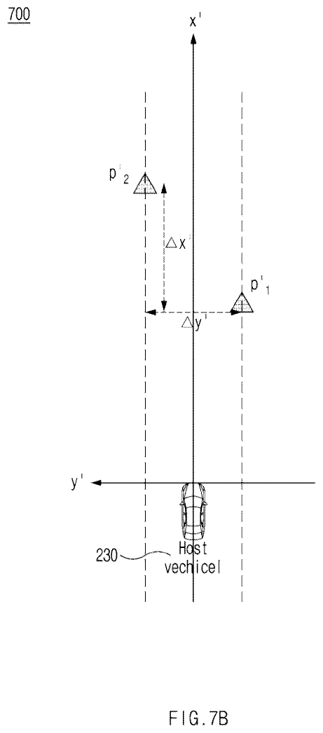

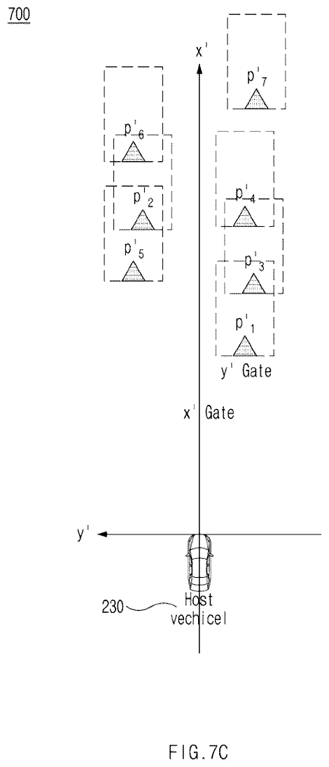

Meanwhile, for convenience of description, FIGS. 4 to 7 are also referenced if necessary, when describing FIG. 3. FIG. 4 is a drawing for describing a scheme for performing point clustering depending on a driving direction in a road boundary estimation algorithm using an autonomous driving sensor and AI according to an embodiment of the present disclosure. FIGS. 5A and 5B are drawings for describing a difference if performing point clustering depending on a driving direction in a road boundary estimation algorithm using an autonomous driving sensor and AI, compared to if simply performing point clustering based on a Euclidean distance, according to an embodiment of the present disclosure. FIG. 6 is a drawing for describing an example of performing point clustering depending on a driving direction in a road boundary estimation algorithm using an autonomous driving sensor and AI, by using a dendrogram technique according to an embodiment of the present disclosure. FIGS. 7A to 7C are drawings for describing a scheme for performing point clustering depending on a driving direction in a road boundary estimation algorithm using an autonomous driving sensor and AI, by defining a new horizontal axis and a new vertical axis on the basis of the driving direction according to an embodiment of the present disclosure.

An AI module for recognizing a road boundary according to the present disclosure may be loaded into, for example, a processor 110 as a part of a software module. Furthermore, an autonomous driving sensor is not limited to only LiDAR 120 shown in FIG. 1. The RADAR 120 for detecting a distance from an external object using a radio wave is also regarded as the autonomous driving sensor in the present disclosure.

In S100 shown in FIG. 3, a region of interest (ROI) which is a main ROI where the autonomous driving sensor 120 will detect an object may be set and a static object which does not move among objects included in the ROI may be determined. For example, because a guardrail 220 corresponds to the static object and constitutes a road boundary in FIG. 2, a certain space surrounding the guardrail 220 corresponds to the ROI according to the present disclosure.

At this time, the AI module according to the present disclosure may receive a plurality of points generated from one or more stopped objects among objects 220, 240, and 250 which are present around the road 210 depending on a current driving direction (e.g., direction D of FIG. 2) together with a coordinate value of each point on coordinates in space in real time from the autonomous driving sensor 120.

Because all the objects 220, 240, and 250 are the stopped objects in the example of FIG. 2, finally, object selection in S100 may be performed on the basis of the ROI. in other words, in the example of FIG. 2, the guardrail 220 may be determined as an object which belongs to the ROI and is stopped in S100.

The reason why the ROI is introduced in S100 is because separately performing a complex computation process which will be described below for the other objects 240 and 250 in S200 may increase the burden of AI computation and because noise in object recognition may be a problem.

Next, in S200, point clustering according to a driving direction (e.g., direction D) for the road boundary may be performed. If the autonomous driving sensor 120 is LiDAR, a large number of points may be generated based on a measured value in which the laser beam hits object particles to be reflected. If the autonomous driving sensor 120 is RADAR, various parameters may be measured, when the radio wave emitted from the RADAR 120 loaded into the vehicle 230 is reflected from an object, and a Doppler effect, a distance, whether the point is moving, or the like may be measured.

In detail, in S200 in the present disclosure, a “driving direction weighted Euclidean distance” between the plurality of points (i.e., two points) recognized by the autonomous driving sensor 120 in S100 may be calculated based on a driving distance according to the driving direction and a weight determined for each reference axis on the coordinates in space (e.g., for each of an X-axis and a Y-axis if presuming a two-dimensional (2D) space and for each of an X-axis, a Y-axis, and a Z-axis if presuming a three-dimensional (3D) space).

For example, if the coordinates in space to be applied in the present disclosure are 2 dimensions, the driving direction weighted Euclidean distance d_{euc} may be calculated by Equation 1 below.

$${d}_{euc} ( {p}_{i} , {p}_{i + 1} ) = \sqrt{{w}_{{x}^{′}} \cdot Δ {x}^{′2} + {w}_{{y}^{′}} \cdot Δ {y}^{′2}} \qquad [ Equation 1 ]$$

Herein, the vertical distance, Δx′, in the driving distance is determined as Δx′=θᵢ₍ᵢ₊₁₎·R, the horizontal distance, Δy′, in the driving distance is determined as Δy′=p̅ᵢ̅₊̅₁̅p̅_̅{̅R̅}̅−p̅ᵢ̅p̅_̅{̅R̅}̅, wₓ′ is the weight on the vertical axis of the relative coordinates generated according to the driving direction, w_{y}′ is the weight on the horizontal axis of the relative coordinates generated according to the driving direction, p_{R} is the center of rotation in the current driving direction on the coordinates in space, R is the radius of rotation in the current driving direction on the coordinates in space, pᵢ and pᵢ₊₁ correspond to the ith point and the i+1th point among the plurality of points, respectively, and θᵢ₍ᵢ₊₁₎ is the angle formed on the basis of the center of rotation by the ith point and the i+1th point.

Referring to FIG. 4 for convenience of description, in S100, the autonomous driving sensor 120 may detect a plurality of points 410 along the guardrail 220 and around the guardrail 220. Points 420 about the object 240 or the like out of the road boundary may also be included in the plurality of points 410. Because the autonomous driving sensor 120 (e.g., RADAR, LiDAR, or the like) is loaded into a vehicle 230 which is currently driving, the plurality of points may be detected according to driving direction D of the vehicle 230 as shown in FIG. 4. However, as described above in S100, the present disclosure may determine the region with the certain size, which surrounds the guardrail 220, as the ROI and may intensively perform S200 and computation according to Equation 1 above for only a point (i.e., 410) which is not moving as a point which belongs to the ROI.

For reference, discrimination between the point 410 which is not moving and a point which is moving may be performed by measuring a speed at which it is away from the vehicle 230 or is close to the vehicle 230 for each point by the above-mentioned Doppler effect and relatively comparing the measured speed with the speed of the vehicle 230 to divide whether the point is static or dynamic, if the autonomous driving sensor 120 is RADAR.

FIG. 5 is a drawing for describing the “driving direction weighted Euclidean distance (calculated in S200)” which is the core of the present disclosure.

For example, seeing FIG. 5A, it may be checked that general Euclidean computation is performed for four points, such as p₁, p₂, p₃, and p₄ which are recognized by the autonomous driving sensor 120. It is fine that the Euclidean distance is understood as the shortest distance connecting two points. If pairing the four points of p₁, p₂, p₃, and p₄ to calculate a Euclidean distance, eventually, because p₁ and p₂ have the shortest Euclidean distance and p₃ and p₄ have the shortest Euclidean distance as shown in FIG. 5A, 2 clusters, (p₁, p₂), and (p₃, p₄), are formed as shown in FIG. 5A.

However, in the same manner as FIG. 5A, it may be very difficult to recognize, for example, a point 410 measured in FIG. 4 as the same shape as a real guardrail 220 shown in FIG. 2 or may be actually impossible to recognize the point 410 as the same shape as the real guardrail 220. This is because it is difficult to reflect the curvature of the guardrail 220, which changes gradually as the vehicle 230 drives in direction D when measuring the Euclidean distance as shown in FIG. 5A on the basis of only the absolute coordinates in space, while not considering the driving direction, although the vehicle 230 is driving and thus the point recognized by the autonomous driving sensor 120 changes from moment to moment.

Thus, the present disclosure proposes the method for introducing Equation 1 above in S200. Thus, the present disclosure is configured to cluster points with the shortest “driving direction weighted Euclidean distance” among the plurality of points and recognize a road boundary or an object (i.e., the guardrail 220) corresponding to the road boundary.

Referring to FIG. 5B, the vehicle 230 is currently turning at a certain radius along the curved road towards driving direction D. In FIGS. 5A and 5B, herein, the vertical distance, Δx′, in the driving distance is determined as Δx′=0ᵢ₍ᵢ₊₁₎·R, the horizontal distance, Ay′, in the driving distance is determined as Δy′=p̅ᵢ̅₊̅₁̅p̅_̅{̅R̅}̅−p̅ᵢ̅p̅_̅{̅R̅}̅, wₓ′ is the weight on the vertical axis of the relative coordinates generated according to the driving direction, w_{y}′ is the weight on the horizontal axis of the relative coordinates generated according to the driving direction, p_{R} is the center of rotation in the current driving direction on the coordinates in space, R^{R} is the radius of rotation in the current driving direction on the coordinates in space, pᵢ and pᵢ₊₁ correspond to the ith point and the i+1th point among the plurality of points, respectively, and θᵢ₍ᵢ₊₁₎ is the angle formed on the basis of the center of rotation by the ith point and the i+1th point. Thus, θ₁₂ is the angle formed between the first recognized point p₁ and the second recognized point p₂ as shown in FIG. 5B. The centerpoint of measurement is the center coordinates p_{R} of center R of the radius of rotation of the vehicle 230.

As it is able to be checked in FIG. 5B, the “driving direction weighted Euclidean distance” is calculated as d_{euc}(pᵢ,pᵢ₊₁)=\sqrt{wₓ′·Δx′²+w_{y′}·Δy′²}. Δx′ and Δy′ are the distance of the vertical component and the distance of the horizontal component calculated according to relative coordinates which changes from moment to moment depending to driving direction D (i.e., the direction identical to the driving direction is defined as the vertical axis x′ and the axis perpendicular to the vertical axis is defined as y′ for two dimensions). Thus, points which are closest on the basis of the “driving direction weighted Euclidean distance” in FIG. 5B may be two clusters, (p₁, p₃), and (p₂, p₄). This leads to a cluster result which is different from applying a general Euclidean technique as it is able to be clearly checked in FIGS. 5A and 5B.

Particularly, assuming that there is a relationship, wₓ′<w_{y}′, between the weight on the vertical axis and the weight on the horizontal axis, the clustering result, such as FIG. 5B, may be more reliably predicted.

Of course, for example, as shown in FIG. 6, it is possible to generate a dendrogram 600 based on the “driving direction weighted Euclidean distance (i.e., Equation 1 above)” for the plurality of points 410 upon the clustering in S200 and hierarchically perform the clustering. In any case, as a result different from the clustering result in FIG. 5A, that is, it is possible to perform clustering of a road boundary-related object in which the curvature of the guardrail 220 and driving direction D are reflected.

It may also be seen as a kind of post-processing from S300. In S300, the validity of the computation performed in S200 may be checked. For example, the AI module according to the present disclosure may determine that a point at which the above-mentioned “driving direction weighted Euclidean distance” is greater than a certain threshold among the plurality of points is noise which does not constitute a road boundary.

In addition, in S400, for example, the post-processing step of determining points (e.g., corresponding to reference numeral 420 in FIG. 4) which are present in a region outside the result of recognizing the road boundary determined in S200 or the object (i.e., the guardrail 220) corresponding to the road boundary as mirroring noise may be executed. However, given that the mirroring noise is a phenomenon occurring as a kind of ghost track is recognized as an error in a lane opposite to the vehicle 230 which is driving, there is a high probability that it will be the result of recognizing the object indicated as the error somewhere near where the terrain of reference numeral 250 in FIG. 2 is located, actually rather than the point corresponding to reference numeral 420 of FIG. 4. The present disclosure proposes a method for removing the mirroring error based on the result of recognizing the road boundary in S300.

In S400, erroneous merge nose may also be processed. In other words, the AI module according to the present disclosure may feed back to an AI object recognition module that the point determined as constituting the road boundary or the object corresponding to the road boundary in S200 is the stopped object and may feed back to the AI object recognition module that the point determined as not constituting the road boundary or the object corresponding to the road boundary is not the stopped object, thus processing point erroneous merge noise.

Thereafter, in S500, the object which is present outside the autonomous vehicle, particularly, the road boundary may be accurately tracked in the state in which the noise processing is completed.

In addition, upon the clustering in S200, a virtual dimensional gate (in the form of a box with a horizontal/vertical length in two dimensions) which surrounds two points with the shortest “driving direction weighted Euclidean distance” may be generated on the basis of relative coordinates generated according to driving direction D. If there are two or more overlapped areas in the dimensional gate, the two or more with each other, thus dimensional gates may be connected accurately recognizing a continuous long object, such as the guardrail 220 of FIG. 2.

FIG. 8 is a block diagram illustrating a computing system 1000 for autonomous vehicle control and object recognition computation according to an embodiment of the present disclosure.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage module 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present disclosure may more advance autonomous driving performance using an autonomous driving sensor (e.g., RADAR or the like) and AI via a technology for accurately recognizing a road boundary or an object, such as a guardrail, which corresponds to the road boundary.

Particularly, the present disclosure may determine a weight for each coordinate axis of the space based on a driving direction and may calculate a Euclidean distance in which the weight is reflected for several points detected on a driving route based on the weight, thus estimating an accurate road boundary suitable for the curvature of the road, although there is, for example, a winding road.

Particularly, the present disclosure may remove noise for a point or the like incorrectly determined as an object which is moving, despite a point which is present in a region out of the region determined as the road boundary even in a point clustering step and a post-processing step subsequent to the point clustering step or a point used to determine the road boundary.

In other words, the present disclosure may post-process a point recognized as an error by the autonomous driving sensor in such a manner as to delete an object out of the road boundary region as noise or reduce an AI confidence score and may implement a robust AI object recognition system and algorithm. The present disclosure may perform point clustering based on a driving route of a vehicle which is currently driving, particularly, the curvature, if generating the road boundary according to the present disclosure, thus detecting the road boundary which is robust to surrounding noise and forms a more accurate curve.

In addition, those skilled in the art may understand various effects other than the effects described above from the present disclosure, via the detailed description of the present disclosure and the accompanying drawings.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A system for recognizing a road boundary or an object corresponding to the road boundary comprising:
a processor configured to recognize, using an artificial intelligence (AI) module, an object which is present in a surrounding environment from data input from an autonomous driving sensor; and
a memory storing the data,
wherein the processor is further configured to perform, using the AI model:
receiving a plurality of points generated from one or more stopped objects among objects which are present around a road depending on a current driving direction together with a coordinate value of each point on coordinates in space in real time from the autonomous driving sensor;
calculating a driving direction weighted Euclidean distance between the plurality of points based on a driving distance according to the driving direction and a weight determined for each reference axis on the coordinates in space;
performing clustering of points with the shortest driving direction weighted Euclidean distance among the plurality of points and recognizing the road boundary or the object corresponding to the road boundary; and
controlling a vehicle based on the clustering result.

2. The system of claim 1, wherein based on that the coordinates in space are two dimensions, the driving direction weighted Euclidean distance d_{euc} is represented as:
$${d}_{euc} ( {p}_{i} , {p}_{i + 1} ) = \sqrt{{w}_{{x}^{′}} \cdot Δ {x}^{′2} + {w}_{{y}^{′}} \cdot Δ {y}^{′2}}$$
wherein Δx′ represents a vertical distance in the driving distance which is computed by using Δx′=0ᵢ₍₊₁₎·R, Δy′, represents a horizontal distance in the driving distance which is computed using Δy′=√p̅ᵢ̅₊̅₁̅p̅_̅{̅R̅}̅−p̅ᵢ̅p̅_̅{̅R̅}̅, wₓ′ represents a weight on the vertical axis of the relative coordinates generated according to the driving direction, w_{y}′ represents a weight on the horizontal axis of the relative coordinates generated according to the driving direction, p_{R} represents a center of rotation in the current driving direction on the coordinates in space, R represents a radius of rotation in the current driving direction on the coordinates in space, pᵢ and pᵢ₊₁ correspond to the ith point and the i+1th point among the plurality of points, respectively, and θᵢ₍ᵢ₊₁₎ represents an angle formed on the basis of the center of rotation by the ith point and the i+1th point.

3. The system of claim 2, wherein the weight on the vertical axis and the weight on the horizontal axis have a relationship, wₓ′<w_{y}′.

4. The system of claim 1, wherein the processor is configured to:
execute, using the AI module, a post-processing step of determining that a point at which the driving direction weighted Euclidean distance is greater than a certain threshold among the plurality of point is noise which does not constitute the road boundary.

5. The system of claim 1, wherein receiving a plurality of points includes:
receiving the coordinate value of each point in real time based on that the stopped objects are present in a predetermined region of interest (ROI).

6. The system of claim 1, wherein the autonomous driving sensor includes radio detection and ranging (RADAR), the stopped objects are determined based on whether there is a speed of movement by a Doppler effect recognized by the RADAR.

7. The system of claim 1, wherein the processor is configured to:
execute, using the AI module, a post-processing step of determining points which are present in a region outside the result of recognizing the road boundary or the object corresponding to the road boundary among the plurality of points as mirroring noise.

8. The system of claim 1, wherein the processor is configured to:
execute, using the AI module, a post-processing step of feeding back that a point determined as constituting the road boundary or the object corresponding to the road boundary is the stopped object and feeding back that a point determined as not constituting the road boundary or the object corresponding to the road boundary is not the stopped object to process point erroneous merge noise.

9. The system of claim 1, wherein the processor is configured to:
generate, using the AI module, a dendrogram based on the driving direction weighted Euclidean distance for the plurality of points upon the clustering to hierarchically perform the clustering.

10. The system of claim 1, wherein the processor is configured to:
generate, using the AI module, a dimensional gate surrounding two points with the shortest driving direction weighted Euclidean distance on the basis of relative coordinates generated according to the driving direction, upon the clustering; and
connect, using the AI module, two or more dimensional gates to recognize the road boundary or the object corresponding to the road boundary, if there are two or more overlapped regions in the dimensional gate.

11. A method for recognizing a road boundary or an object corresponding to the road boundary, the method comprising:
receiving, by a processor, using an artificial intelligence (AI) module, a plurality of points generated from one or more stopped objects among objects which are present around a road depending on a current driving direction together with a coordinate value of each point on coordinates in space in real time from a autonomous driving sensor;
calculating, by the processor, using the AI module, a driving direction weighted Euclidean distance between the plurality of points based on a driving distance according to the driving direction and a weight determined for each reference axis on the coordinates in space;
performing, by the processor, using the AI module, clustering of points with the shortest driving direction weighted Euclidean distance among the plurality of points and recognizing the road boundary or the object corresponding to the road boundary; and
controlling a vehicle based on the clustering result.

12. The method of claim 11, wherein based on that the coordinates in space are two dimensions, the driving direction weighted Euclidean distance d_{euc} is represented as:
$${d}_{euc} ( {p}_{i} , {p}_{i + 1} ) = \sqrt{{w}_{{x}^{′}} \cdot Δ {x}^{′2} + {w}_{{y}^{′}} \cdot Δ {y}^{′2}}$$
wherein Δx′ represents a vertical distance in the driving distance which is computed by using Δx′=θᵢ₍ᵢ₊₁₎·R, Δy′, represents a horizontal distance in the driving distance which is computed using Δy′=√p̅ᵢ̅₊̅₁̅p̅_̅{̅R̅}̅−p̅ᵢ̅p̅_̅{̅R̅}̅, wₓ′ represents a weight on the vertical axis of the relative coordinates generated according to the driving direction, w_{y}′ represents a weight on the horizontal axis of the relative coordinates generated according to the driving direction, p_{R} represents a center of rotation in the current driving direction on the coordinates in space, R represents a radius of rotation in the current driving direction on the coordinates in space, pᵢ and pᵢ₊₁ correspond to the ith point and the i+1th point among the plurality of points, respectively, and θᵢ₍ᵢ₊₁₎ represents an angle formed on the basis of the center of rotation by the ith point and the i+1th point.

13. The method of claim 12, wherein the weight on the vertical axis and the weight on the horizontal axis have a relationship, wₓ′<w_{y}′.

14. The method of claim 11, further comprising:
a post-processing step of determining that a point at which the driving direction weighted Euclidean distance is greater than a certain threshold among the plurality of point is noise which does not constitute the road boundary.

15. The method of claim 11, wherein receiving a plurality of points includes:
receiving the coordinate value of each point in real time, based on that the stopped objects are present in a predetermined region of interest (ROI).

16. The method of claim 11, wherein the autonomous driving sensor includes radio detection and ranging (RADAR), the stopped objects are determined based on whether there is a speed of movement by a Doppler effect recognized by the RADAR.

17. The method of claim 11, further comprising:
a post-processing step of determining points which are present in a region outside the result of recognizing the road boundary or the object corresponding to the road boundary among the plurality of points as mirroring noise.

18. The method of claim 11, further comprising:
a post-processing step of feeding back that a point determined as constituting the road boundary or the object corresponding to the road boundary is the stopped object and feeding back that a point determined as not constituting the road boundary or the object corresponding to the road boundary is not the stopped object to process point erroneous merge noise.

19. The method of claim 11, further comprising:
generating a dendrogram based on the driving direction weighted Euclidean distance for the plurality of points upon the clustering to hierarchically perform the clustering.

20. The method of claim 11, further comprising:
generating a dimensional gate surrounding two points with the shortest driving direction weighted Euclidean distance on the basis of relative coordinates generated according to the driving direction, upon the clustering; and
connecting two or more dimensional gates to recognize the road boundary or the object corresponding to the road boundary, if there are two or more overlapped regions in the dimensional gate.
